(19) United States
(12) Patent Application Publication
(10) Pub. No.: US 2016/0064135 A1
(43) Pub. Date: Mar. 3, 2016

(54) ELECTROMAGNETIC COIL FOR RETARDER

(71) Applicant: TBK CO., LTD., Machida-shi ,Tokyo (JP)

(72) Inventors: Akihiro MIYOSHI, Machida-shi Tokyo (JP); Junya KANEKO, Machida-shi Tokyo (JP); Takurou ISHIKAWA, Machida-shi Tokyo (JP); Mitsuyoshi OBA, Machida-shi Tokyo (JP)

(73) Assignee: TBK Co.,Ltd.

(21) Appl. No.: 14/442,395

(22) PCT Filed: Sep. 3, 2014
(86) PCT No.: PCT/JP2014/073167

§ 371 Date: May 12, 2015

(51) Int. Cl. H01F 27/28

(52) U.S. Cl. CPC H01F 27/2823

(57) ABSTRACT

An electromagnetic coil for a retarder. A lead wire draw out portion includes a holder having a bottom portion through which a lead wire of the electromagnetic coil is passed and a reservoir to be filled with an adhesive.

### RELATED APPLICATION

This application is a National Phase entry of PCT Application No. PCT/JP2014/0731671, filed Sep. 3, 2014, the disclosure of which is hereby incorporated by reference in its entirety.

### FIELD OF THE INVENTION

The present invention relates to an electromagnetic coil for a retarder to be mounted on a car as a brake assisting device, for instance, and more particularly relates to an electromagnetic coil having an improved lead wire draw out portion for a retarder.

### BACK GROUND ART

In a conventional electromagnetic coil for a retarder, lead wires, connected to a leading end and a trailing end of the electromagnetic coil, respectively, are drawn out away from the electromagnetic coil and fixed to the outside of a molded electromagnetic coil. Accordingly, water is liable to enter into the coil along the lead wire from the outside of the molded coil, so that there is such a risk that the waterproof integrity of the coil is lowered.

Japanese Utility Model Application No. 15963/1993 is an example of the prior art.

FIG. 4 shows a conventional electromagnetic coil for a retarder and FIG. 5 shows a lead wire draw out portion of the coil. In the conventional electromagnetic coil 1, a draw out portion 3 of a lead wire 2 is composed of an O-ring 4 and a rubber bush 5, each surrounding an outer peripheral surface of the lead wire 2, and a rubber bush 6 for urging the O-ring 4 to the rubber bush 5, so as that water is inhibited from entering into the draw out portion 3 of the lead wire 2 and that a clearance between the lead wire 2 and the coil 1 is inhibited from being formed due to the dispersion of a finished outer diameter of the lead wire 2 or the deformation of the outer diameter of the lead wire 2 due to an outside pressure applied on the lead wire 2. Further, the electromagnetic coil 1 for the retarder, except for the lead wire 2 is encased by insulating material 7 so as to inhibit resin of high temperature and pressure in the electromagnetic coil 1 from being leaked to the outside through the draw out portion 3 of the lead wire 2.

However, in such a conventional electromagnetic coil 1 for retarder, it is necessary to set the lead wire 2 as passing through the O-ring 4 and the rubber bushes 5 and 6 for increasing a holding pressure of the lead wire 2. It is difficult to carry out such operation in an automated manner, and to thereby reduce the manufacturing cost of the electromagnetic coil 1. Further, it is necessary to reduce the extent of the finished outer diameter of the lead wire 2 and to use a coating 8 made of Teflon (Registered Trade Name) having a smaller thermal deformation, in order to reduce the holding pressure of the O-ring 4, and the rubber bushes 5 and 6, resulting in an increase of manufacturing cost.

The present invention addressed the above noted defects in the prior art.

### SUMMARY OF THE INVENTION

An electromagnetic coil according to the present invention includes lead wire draw out portion comprising a holder having a bottom portion through which a lead wire of the electromagnetic coil is passed and a reservoir to be filled with an adhesive.

The above lead wire draw out portion is provided at both of a leading end and a trailing end of the electromagnetic coil.

The lead wire draw out portion is fixed on an outer peripheral surface of a molded electromagnetic coil.

According to the electromagnetic coil for the retarder of the present invention, the number of parts of the lead wire draw out portion can be reduced, the production process can be automated, and the manufacturing cost thereof can be reduced.

### BRIEF DESCRIPTION OF THE DRAWINGS

FIG. 1 is a plan view of an electromagnetic coil for a retarder in accordance with the present invention.

FIG. 2 is a sectional view of a lead wire draw out portion of the electromagnetic coil depicted in FIG. 1.

FIG. 3 is, similar to FIG. 2, but with arrows depicting the application of water pressure.

FIG. 4 is a plan view of an electromagnetic coil of a conventional retarder.

FIG. 5 is a sectional view depicting a lead wire draw out portion of the electromagnetic coil depicted in FIG. 4.

### DETAILED DESCRIPTION

An embodiment of an electromagnetic coil of a retarder of the present invention will be explained with reference to the drawings.

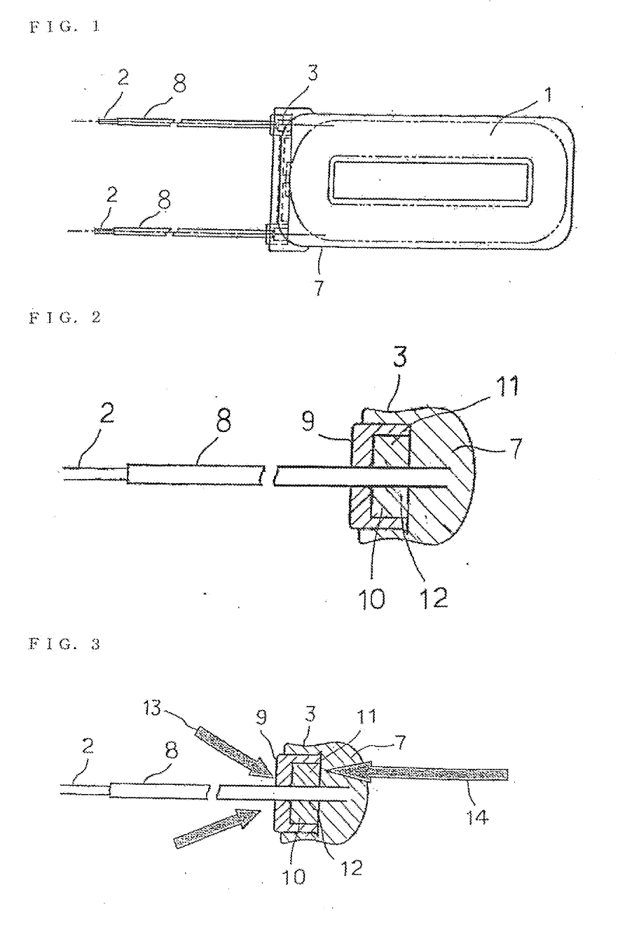

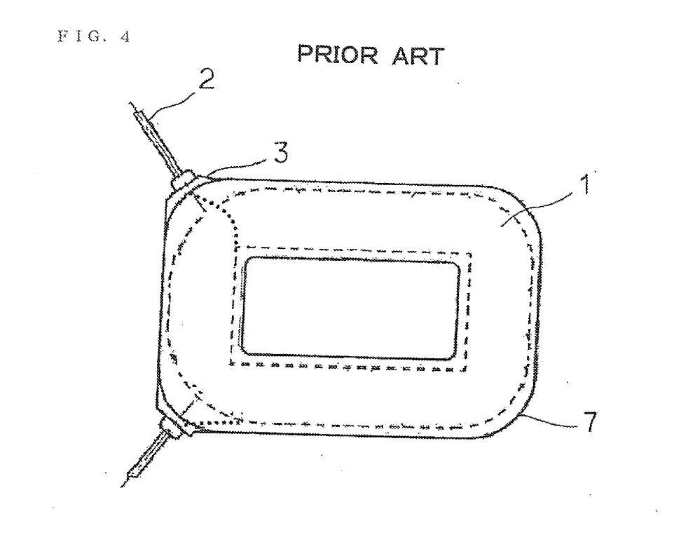

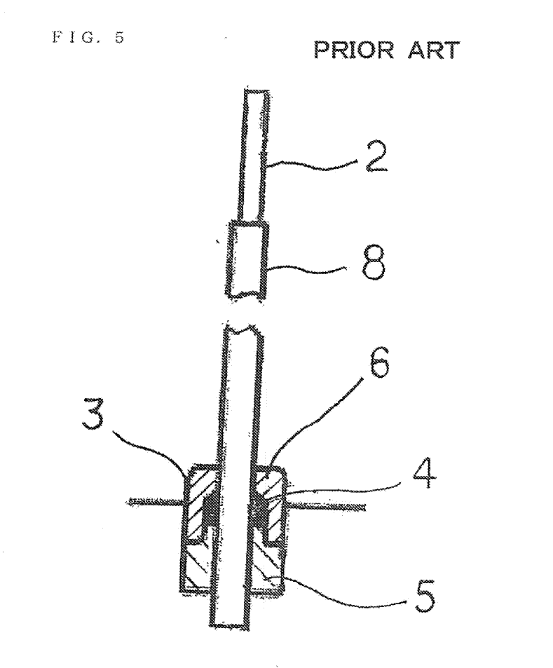

In embodiments, a lead wire draw out portion 3 is comprised, as shown in FIG. 1 and FIG. 2, of a holder 11 in the shape of a cup having a bottom portion 9 through which a lead wire 2 is passed and includes a reservoir 10 of for adhesive 12. In embodiments, the reservoir 10 is filled with the adhesive 12, and after the adhesive 12 is hardened, the lead wire draw out portion 3 is fixed on an outer peripheral surface of a molded electromagnetic coil 1.

A water pressure 13 applied to the lead wire draw out portion 3 from the outside and a resin pressure 14 applied to the lead wire draw out portion 3 from the inside of the electromagnetic coil are isolated the adhesive 12.

It is possible to carry out automatically such processes that the lead wire 2 is passed through the bottom portion 9 of the holder 11, that the reservoir 10 is filled with the adhesive 12 and the adhesive 12 is then hardened, such that it is possible to reduce the manufacturing cost.

The clearance formed by the diminuation of the finished outer diameter of the lead wire 2 is filled with the adhesive 12 when the reservoir 10 is filled with the adhesive 12.

An inexpensive coating 8 can be used for the lead wire 2, because the thermal deformation of the lead wire 2 is compensated by the resilient deformation of the adhesive 12.

It is not necessary to use the O-ring 4 and the bushes 5 and 6 used in the conventional lead wire draw out portion 3, so that the number of the parts can be reduced and the manufacturing cost can be lowered.

1. An electromagnetic coil for a retarder, the electromagnetic coil presenting an outer peripheral surface, comprising a lead wire draw out portion having a holder in the shape of a cup having a bottom portion through which a lead wire of the electromagnetic coil is passed and a reservoir to be filled with an adhesive, wherein the holder is fixed on an outer peripheral surface of the electromagnetic coil.

2. The electromagnetic coil as claimed in claim 1, wherein the lead wire draw out portion is provided at both a leading end and a trailing end of the electromagnetic coil.

3. (canceled)
